(19) United States
(12) Patent Application Publication
(10) Pub. No.: US 2014/0214823 A1
(43) Pub. Date: Jul. 31, 2014

(54) VIRTUAL VISITOR'S CENTER APPLICATION FOR THE DIGITAL COMMUNITY

(71) Applicant: Whap, Inc., Portland, OR (US)

(72) Inventor: William Cook Barron, JR., Portland, OR (US)

(73) Assignee: Whap, Inc., Portland, OR (US)

(21) Appl. No.: 13/967,912

(22) Filed: Aug. 15, 2013

Related U.S. Application Data
(60) Provisional application No. 61/758,693, filed on Jan. 30, 2013.

(51) Int. Cl. G06F 17/30

(52) U.S. Cl. CPC G06F 17/3053
USPC 707/731

(57) ABSTRACT

Systems and methods for providing a social media tool that permits users to identify “what to do” in a particular geographical area in real-time. This is accomplished by utilizing the rate of support (or “likes”) localized topics receive from users in a particular geographical area. A topic can be a place, activity, event, concept, value, brand, etc. A user may operate an application on a computing device to see a list of popular topics in their area. The area may be any defined geographical area, such as a city, stadium, event, etc. The users can like topics, add new topics, add photos, comments, or other content to topics, and subscribe to (or “follow”) their favorite topics. Users can view topics in any geographical region, but they can only contribute likes or content for the particular geographical area in which they are present.

### BACKGROUND

Social media has expanded greatly in the past several years. Among other things, this growth has been fueled by the increased usage of personal communication devices (e.g., smart phones). Social media tools currently exist to allow users to connect with friends and family (e.g., FACEBOOK®), business acquaintances (e.g., LINKEDIN®), media (e.g., YOUTUBE®), and locations (e.g., YELP®). As more users continue to utilize mobile communication devices, social media will continue to grow.

Social media marketing is also growing and is expected to continue to do so. Since social networks are daily destinations for millions of users and the networks often have access to information about their users (e.g., demographics, connections, interests, habits, etc.), there is a significant opportunity for delivering targeted advertising to users. Social media marketing programs may focus on efforts to create content that encourages users to share it with their social networks. A marketing message of an entity (e.g., company or brand) may spread from user to user, and may resonate because it comes from a trusted, third-party source, as opposed to the marketing entity itself.

### BRIEF DESCRIPTION OF THE DRAWINGS

Various embodiments in accordance with the present disclosure will be described with reference to the drawings, in which:

FIG. 1 illustrates an exemplary embodiment of a system architecture constructed in accordance with the present disclosure.

FIG. 2 illustrates a block diagram of a personal computing device according to an embodiment.

FIG. 3 illustrates a block diagram of a content collection and distribution (CCD) server according to an embodiment.

FIG. 4 illustrates a table demonstrating location-based bidding according to an embodiment.

FIG. 5 illustrates a display of a personal computing device when displaying a list of popular topics.

FIG. 6 illustrates a display of a personal computing device when displaying a list of popular people.

FIG. 7 illustrates a display of a personal computing device when displaying a list of people interested in a particular topic.

FIG. 8 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present invention relate to providing a social media tool that permits users to identify “what to do” in a particular geographical area in real-time. Among other ways, this is accomplished by utilizing the rate of support (or “likes”) localized topics and users receive from users in a particular geographical area. A topic can be nearly anything, such as a place, activity, event, concept, value, brand, etc. In general, a user may operate an application on a personal computing device to see a list of popular topics and users in their area. The area may be any defined geographical area, such as a city, stadium, event, etc. The users can like topics, like users, add new topics, add photos, comments, or other content to topics, and subscribe to (or “follow”) their favorite topics. Users can view topics in any geographical region, but they can only contribute likes or content for the particular geographical area in which they are present (i.e., authorized users). Topics and users that are most popular (e.g., fastest rate of likes, or other metric, etc.) move to the top of the popular topic list. Additionally, the more a user uses the system, the more that user's popularity increases. Users can view how popular they are with specific topics and attempt to move up a popularity list to become the most popular person in their geographical area for a particular topic (e.g., the biggest fan of a topic).

The system provides a type of competitive environment where users are motivated to make their favorite topics the most popular in a geographical area, become popular with their favorite topics, and become popular themselves. This motivation may stem from brand loyalty, identification with a geographical area (e.g., a city), fan support, etc. Since the system is tied to geographical locations, the system is operative to provide location-based web and mobile marketing.

As an example, in some embodiments a business is able to purchase their topics (e.g., brand, etc.) on a pay-per-like system and bid on geographical locations for those topics to be displayed in preferred spots at the top of the popular list. Whenever topics are displayed, the highest bidders for that geographical area get their topics displayed in one of the preferred spots. This allows businesses to target specific areas with their advertising and to obtain real-time market reports for their brand. This feature is described in more detail below.

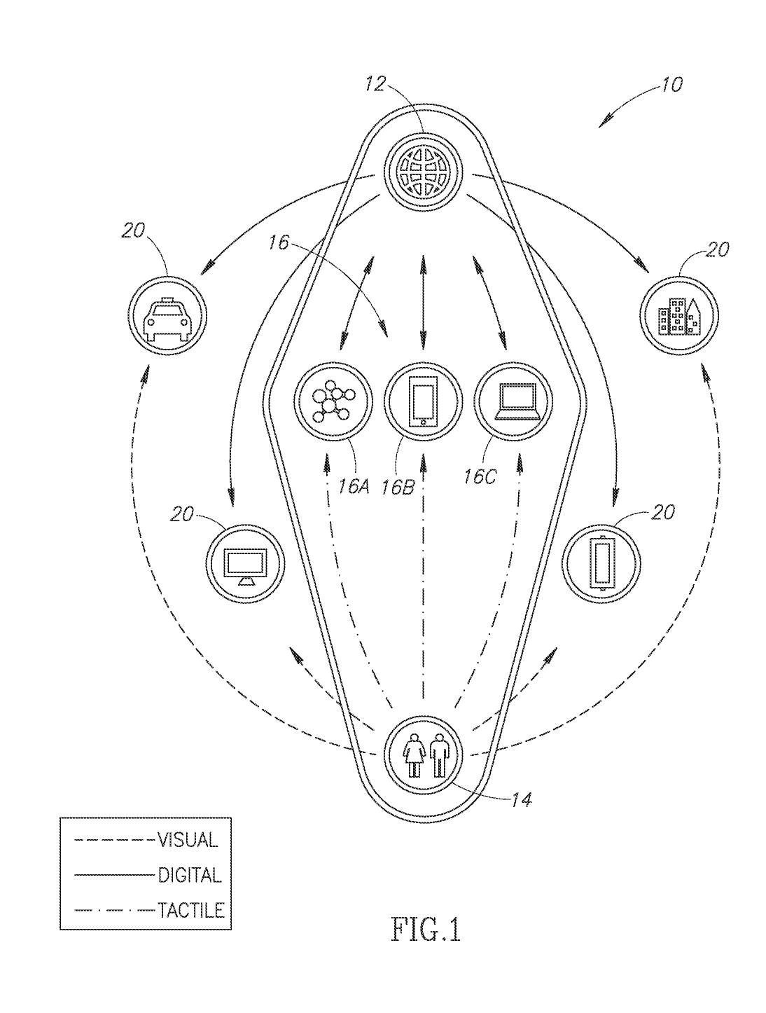

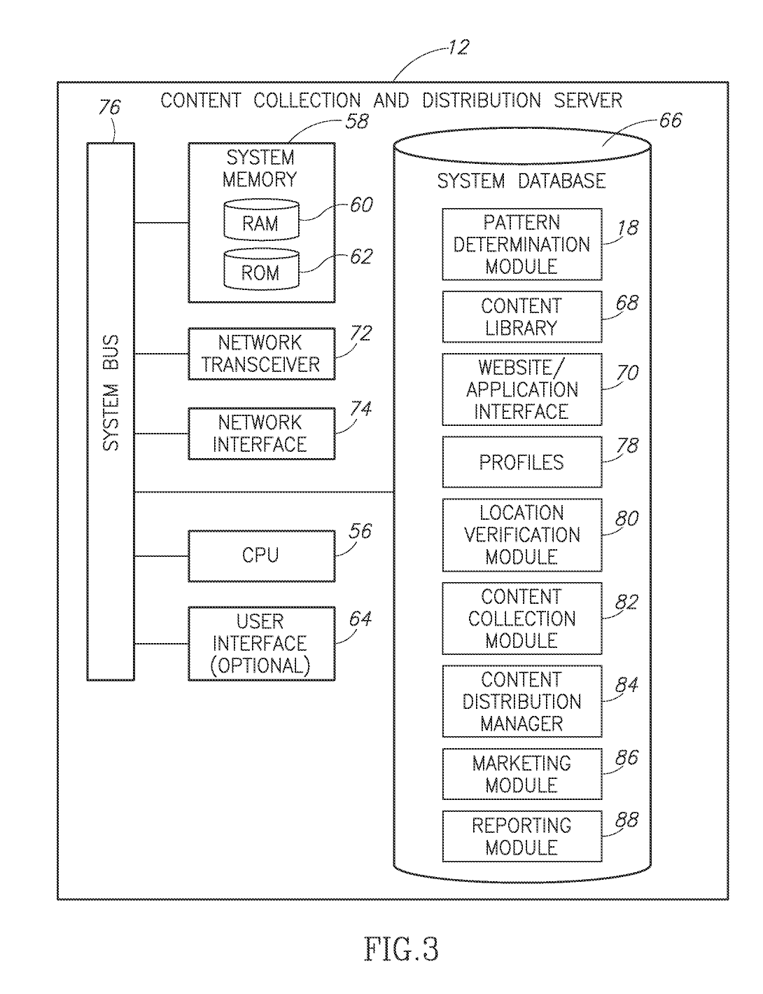

Referring to FIG. 1, a system 10 is shown that includes a content collection and distribution (CCD) server 12 (e.g., cloud computing server, server network) that functions as a collection device for input received from users 14 located within a given geographical area. In some embodiments, the system 10 may be organized around various scales (e.g., state, city, municipality, campus, university, stadium venue, group of buildings, individual building, etc.). Connection and participation with the system 10 is regulated through a personal computing device 16 (e.g., smart phone, tablet, etc.) and/or a computer application that allows only those users 14 currently in the specified area to submit content in any form (e.g., photos, videos, statuses, comments, locations, likes, tags, links, etc.) to the CCD server 12. Users 14 may view content of the system 10 from any geographic area. FIG. 1 illustrates interactive architecture 16A, smart phones 16B, and computers 16C as non-limiting examples of computing devices 16. This content is collated and a pattern determination module 18 (see FIG. 3) of the CCD server 12 which determines patterns and trending topics by analyzing content received from users 14 via their personal computing devices 16.

The results from the pattern determination module 18 are available in the application and form the popular trend and interests of the specified area. In this way, the application becomes a supplement and compliment to the area's tourism industry. The application forms a “virtual visitor center” where users 14 can connect and see the most trending topics (e.g., events, activities, locations, restaurants, thoughts, etc.) localized to their area. This application relies on input from users 14 to provide crowd-sourced advertising for what is important to them at a specific scale. The most liked, most rapidly liked, well reviewed, and/or popular information will be trending and will come to the forefront of the application interface for interaction with the user.

As an example, the application may be offered in a city, such as Las Vegas, Nev. In this city, the application may be configured to operate with multiple hotel resorts by using the application in conjunction with digital surfaces 20 (e.g., smart phones, tablets, billboards, marquees, signs, art installations, computers, terminals, theaters, televisions, point-of-sale displays, mobile screens on cabs and buses, etc.) across the city to form an efficient and immersive method of interaction between the trending media and the users 14.

The interaction between the CCD server 12 and various digital surfaces 20 is depicted in FIG. 1. As shown, users 14 within a particular geographic scale utilize computing devices 16 to upload content to the CCD server 12. The CCD server 12 analyzes the content and then sends content or information for display on one or more digital surfaces 20 and the user's computing devices 16 throughout the particular geographic scale. Other users 14 in the geographic scale view the digital surfaces 20 and can react to the viewed content or information by submitting additional content to the CCD server 12, continuing the cycle.

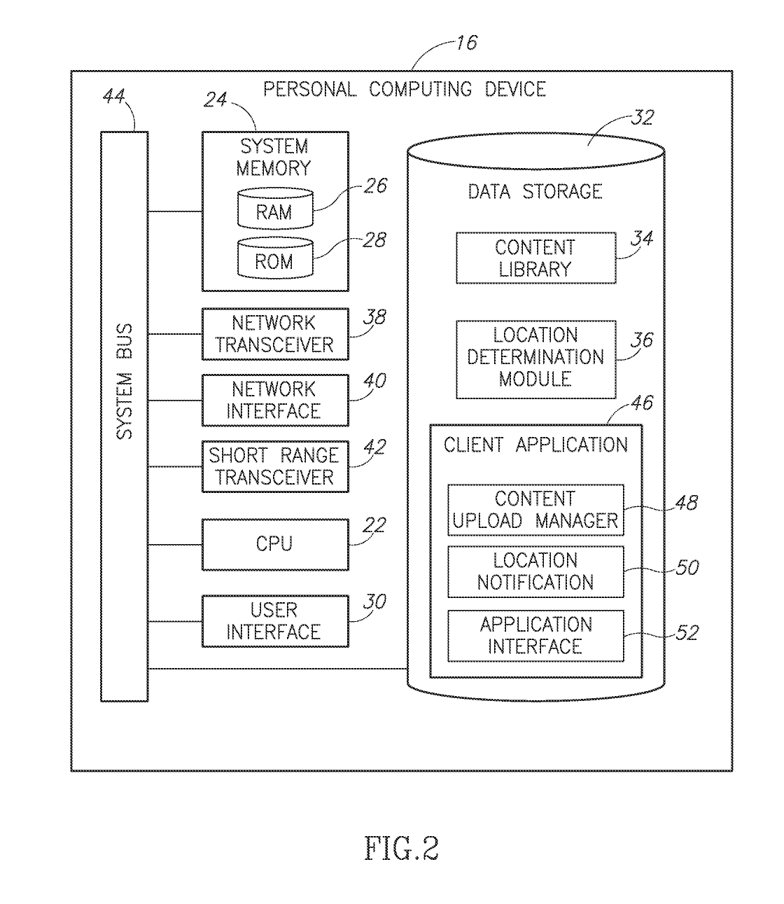

FIG. 2 shows a block diagram view of a personal computing device 16 that may be representative of any of the personal computing devices (e.g., smart phone, tablets, computers, terminals, interactive architecture) shown in FIG. 1. The personal computing device 16 may include, but is not limited to, one or more processor devices including a central processing unit 22 (CPU). The CPU 22 may be responsible for executing computer programs stored on the personal computing device's system memory 24, which may include volatile (RAM) memory 26 and nonvolatile (ROM) memory 28. The personal computing device 16 may also include a user interface 30 that allows a user 14 to interact with the personal computing device's software and hardware resources. The user interface 30 may include various inputs (e.g., keyboard, mouse, touchscreen, microphone, etc.) and outputs (e.g., display, speakers, etc.).

The personal computing device 16 further includes a system data storage structure 32 that includes applications and/or application plug-ins (e.g., web-browsers, browser plug-ins, client applications, access provider utilities, etc.) that may facilitate a user 14 of the personal computing device 16 interacting with various other entities over one or more wired and/or wireless data communication networks.

The system data storage structure 32 may also include a content library 34 that includes a user's downloaded, or otherwise acquired, content (e.g., photos, movies, home videos, text, audio, software applications, etc.).

The system data storage structure 32 of the personal computing device 16 may also include a location determination module 36 configured to determine current geo-location data for the personal computing device. The geo-location data (e.g. longitude and latitude) can be obtained in several possible ways. In one embodiment, the personal computing device 16 may have built-in global positioning system (GPS). Other possible location determination technologies include Wi-Fi®, 3G, approximate triangulation, or last known location of the user. Other known location technologies may also be implemented in the personal computing device 16.

The personal computing device 16 may also include a network transceiver 38 and a network interface 40 that allow the personal computing device to communicate across a data communications network (e.g., the Internet) using wired and/or wireless technology. The personal computing device 16 may also include an optional short-range transceiver 42 (e.g., a Bluetooth® or a Wi-Fi® enabled communications transceiver) that allows the personal computing device to wirelessly communicate with one or more electronic devices. Further, the personal computing device 16 may include a system bus 44 that facilitates data communications amongst all the hardware resources of the personal computing device.

The system data storage structure 32 of the personal computing device 16 also includes a client application 46 including a content upload manager 48, a location notification module 50, and an application interface 52 for interacting with the CCD server 12. Using these components, the client application 46 is operative to send content and geo-location data to the CCD server 12. The application interface 52 also allows the user 14 to receive content from the CCD server 12 for consumption by the user of the personal computing device 16.

FIG. 3 shows a block diagram view of the CCD server 12 of FIG. 1. The CCD server 12 may include, but is not limited to, one or more processor devices including a central processing unit 56 (CPU). The CPU 56 is generally responsible for executing computer programs stored on the CCD server's system memory 58, which may include volatile (RAM) memory 60 and nonvolatile (ROM) memory 62. The CCD server 12 may also include a user interface 64 that allows a user/administrator to interact with the CCD server's software and hardware resources.

The CCD server 12 also includes a system database 66 that includes a content library 68, as well as a hosted website or application interface 70 including various graphical user interface (GUI) components (e.g., static html and dynamic components, such as java-based applications) that may facilitate user 14 interactions. The CCD server 12 may also include a network transceiver 72 and a network interface 74 for transmitting and receiving data content (e.g., such as content received from a client computing device 16 and delivered to client computing devices or digital surfaces 20) over the data communication network. The CCD server 12 may also include a system bus 76 that facilitates data communications amongst the hardware resources of the CCD server.

The system database 66 also includes a profiles database 78 operative to store profiles for users, businesses, topics, etc. User profile information may include general account information, preferences, interest profiles, user connections, etc. Business profiles may include advertising content related to topics, sponsored topics, marketing/advertising data, etc.

The system database 66 of the CCD server 12 also includes a location verification module 80 that is configured to receive geo-location data from personal computing devices 16 and to verify that a particular personal computing device is located within a specified geographic scale (e.g., a city, etc.) when content is received from the personal computing device. As discussed above, in some embodiments only users within a particular geographic scale are permitted to upload content for that geographic scale.

The system database 66 of the CCD server 12 also includes a content collection module 82 configured to receive and organize content from a plurality of personal computing devices 16. As discussed above, the pattern determination module 18 is operative to analyze the content to determine what is currently “trending.” Generally, the pattern determination module 18 is able to identify and rank the most liked, most rapidly liked, most well reviewed, and/or otherwise popular information or topics for a particular geographic scale.

The system database 66 of the CCD server 12 may also include a content distribution manager application 84 to facilitate delivery of various content or information (e.g., lists of topics, lists of users, photos, videos, statuses, comments, locations, likes, tags, links, etc.) stored in the CCD server's content library 68 based on the determinations made by the pattern determination module 18. The content distribution manager application 84 may distribute the content for display on users' personal computing devices 16 located in the geographic scale to which the information relates. The content distribution manager application 84 may also send content for display on one or more digital surfaces 20 (e.g., smart phones, tablets, billboards, marquees, signs, art installations, computers, terminals, theaters, televisions, point-of-sale displays, mobile screens on cabs and buses, etc.) located within the geographic scale (e.g., city, stadium, etc.) so that users 14 within the geographic scale may consume the trending or popular content and interact with the system 10 using their personal computing devices 16.

The system database 66 may also include a marketing module 86. The marketing module 86 allows businesses to sponsor topics. Sponsorship allows businesses to obtain existing content of their sponsored topic and provides businesses control over accepting or rejecting new media content supplied by users, thus giving businesses a direct link to their customers. The marketing module 86 may also give businesses the ability to support or “like” their customers. For example, businesses may insert priority content including hyperlinks and provide special promotions to customers that like them most frequently. This allows businesses to increase customer loyalty by rewarding the top supporters of their brand.

The marketing module 86 is also operative to provide sponsored businesses with location-based bidding. As discussed above, popular topics are displayed in a list according to their popularity with other users. The marketing module 86 allows businesses to occupy preferred spots at the top of the popular list by bidding on geographical locations to target their customers. In some embodiments, a winning bid is based on two factors: the amount of the bid, and the interest profile of the user 14. A user's interest profile utilizes the history of the user's likes to determine in what topics they are interested. This metric may be weighed against the amount of the bid to determine the winner or winners of the preferred spots for each particular user. As can be appreciated, location-based bidding gives businesses the ability to only purchase high-interest advertising, directed to high-interest customers, in high-interest geographical areas.

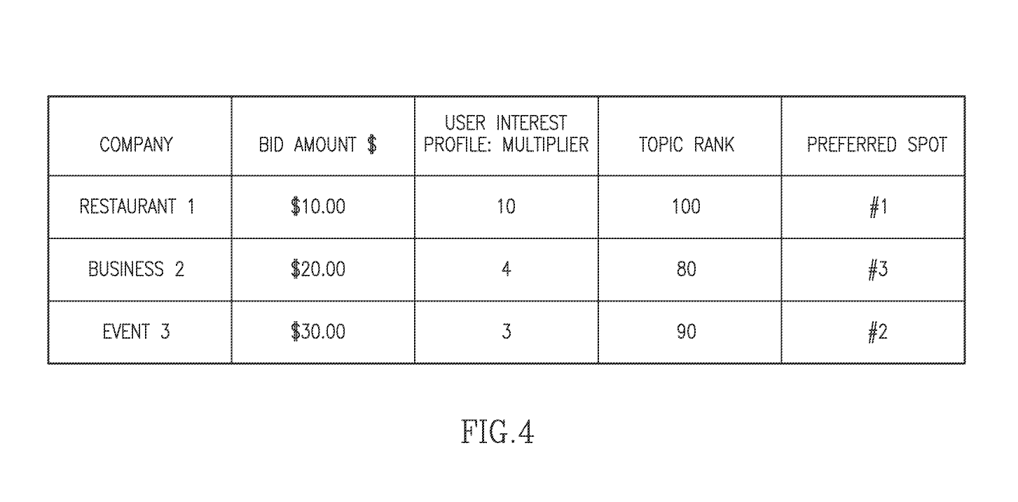

FIG. 4 provides a table that illustrates an example of location-based bidding. In this example, restaurant 1, business 2, and event 3 have each identified their customers are in a specific geographical area. They all place bids for preferred spots on the topic list for that particular geographical area. Restaurant 1 bids $10, business 2 bids $20, and event 3 bids $30.

When a particular user opens the system application 46 on his or her computing device 16 within the specific geographical area, an auction specific to that user 14 automatically occurs. The dollar amount of the businesses' bids is adjusted by a multiplier corresponding to the user's interest profile to determine each business's topic rank. In this example, the user's interest profile indicates that the user is more interested in restaurant 1 (multiplier of 10) than in business 2 (multiplier of 4) or event 3 (multiplier of 3). For example, the user may most often like restaurants, and less frequently likes businesses or events. Thus, the topic ranks for the restaurant 1, business 2, and event 3 are 100, 80, and 90, respectively. Accordingly, the restaurant 1 gets preferred spot #1, event 3 gets preferred spot #2, and business 2 gets preferred spot #3 on the user's customized popular list displayed on the user's personal computing device 16. In some embodiment, the business may pay the amount of their bid when the user opens and views the business's preferred topic.

The system database 66 of the CCD server 12 also includes a reporting module 88. The reporting module 88 is operative to provide businesses with analytic marketing reports, including: where their likes and submitted content are coming from geographically, their popularity level at any time of the year, month, week, day, hour, etc., and demographic information of their customers including their customers' interest profile. Businesses can download reports from the CCD server 12 at any time, which provides them with real-time, up to the minute marketing reports.

The reporting module 88 may also be used by businesses for market analysis, e.g., for company expansion. Businesses can determine whether the demographics and interests of users in a geographical area match those of their customers. Additionally, businesses can utilize the system 10 to test new products or services by creating a topic with a description of the new product or service, and analyzing user responses to it using the data provided by the reporting module. In some embodiments, the responses from users may include votes for a particular feature of a product (e.g., flavor, color, etc.), giving the businesses even more direct feedback from high-interest customers.

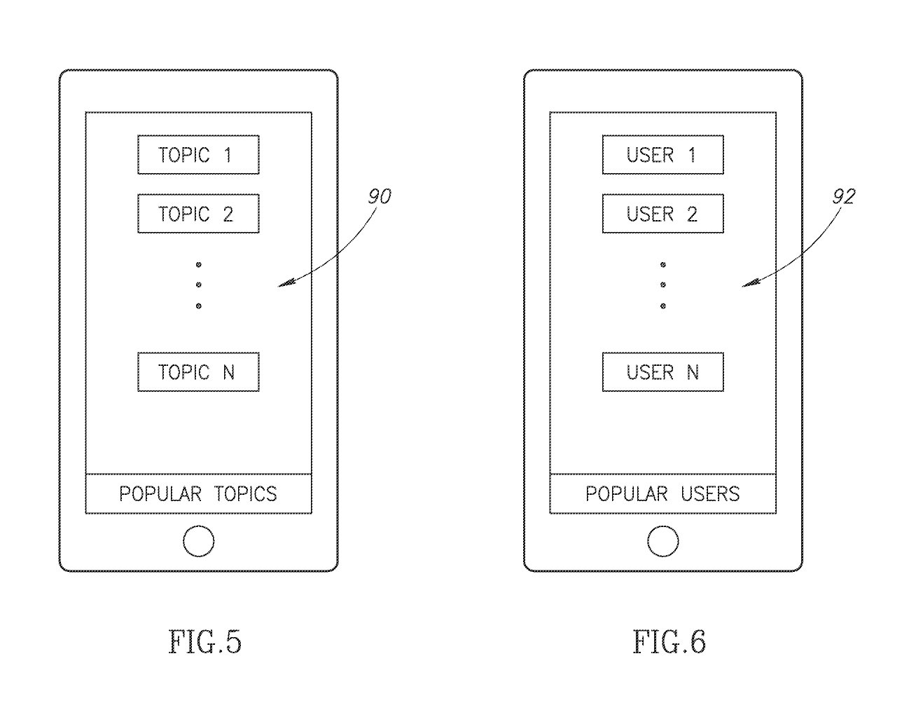

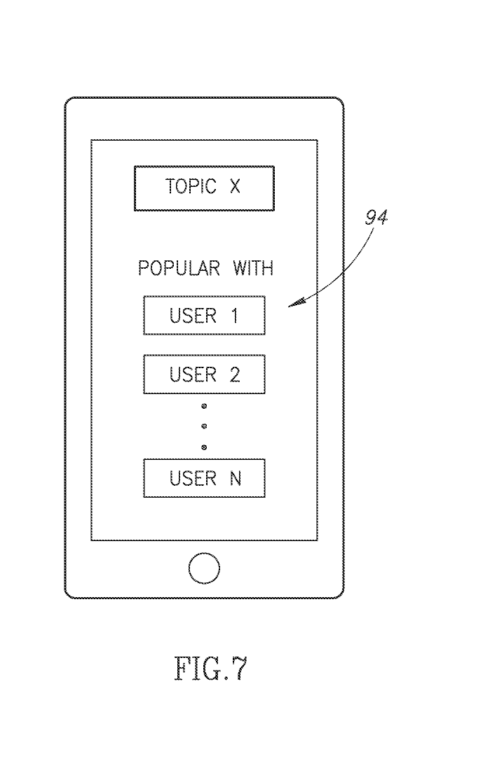

As discussed above, the system 10 shows users 14 what is popular in a particular geographical area in real-time, thus answering the question of “what to do?” in a particular area at a particular instant. Unlike other systems that are based around search features, the system 10 is based around a presentation feature. As shown in FIG. 5, users are presented with a list 90 of popular topics ranked in real-time by feedback (e.g., rate of likes) provided by other users. The lists may be customized and displayed on a user's computing device 16, and the lists may also appear on one or more digital surfaces 20 throughout a geographical area. Users can socially contribute their voice by supporting or liking what they see or by adding content. Additionally, as shown in FIG. 6, users can become popular the more they use the system 10. FIG. 6 illustrates a list 92 of users ranked by their popularity as determined by the system 10 in real-time. Generally, the more topics liked by a user 14, the more topics that like a user, and the more friends a user invites to the system 10, the more a user's popularity increases. Other factors may also be used to determine a particular user's popularity. As shown in FIG. 7, the system 10 may rank users' popularity with respect to a particular topic. FIG. 7 illustrates a popularity list 94 of N users for the topic X.

In some embodiments, the system 10 is configured for integration with one or more other social media tools (e.g., FACEBOOK®, TWITTER®, etc.). This feature further leverages the social aspect of the system 10 by introducing users to the system and providing added visibility to the system.

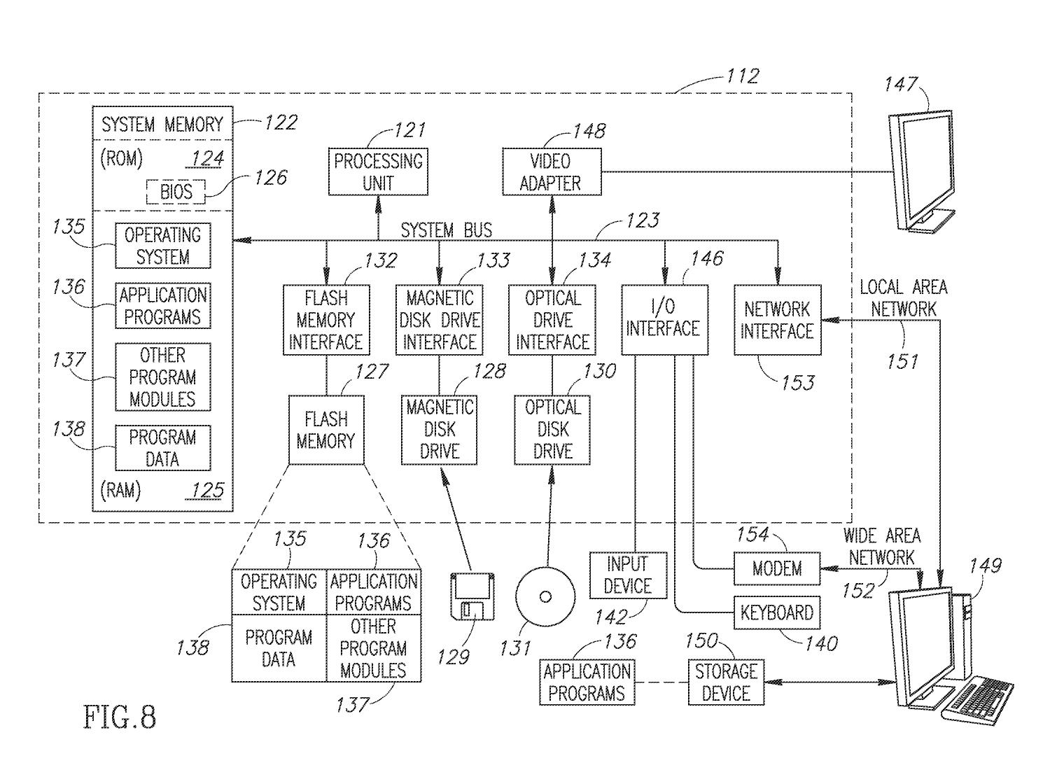

FIG. 8 is a diagram of hardware and an operating environment in conjunction with which implementations of the system 10 (e.g., the CCD server 12, computing devices 16, etc.) may be practiced. The description of FIG. 8 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, tablet computers, smartphones, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 8 includes a general-purpose computing device in the form of a computing device 112. The CCD server 12 and the computing devices 16 may be implemented using one or more computing devices like the computing device 112.

The computing device 112 includes a system memory 122, the processing unit 121, and a system bus 123 that operatively couples various system components, including the system memory 122, to the processing unit 121. There may be only one or there may be more than one processing unit 121, such that the processor of computing device 112 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like. The computing device 112 may be a tablet computer, a smart phone, a conventional computer, a distributed computer, or any other type of computer.

The system bus 123 may be any of several types of bus structures including a memory bus or memory controller, a peripheral bus, and a local bus using any of a variety of bus architectures. The system memory 122 may also be referred to as simply the memory, and includes read only memory (ROM) 124 and random access memory (RAM) 125. A basic input/output system (BIOS) 126, containing the basic routines that help to transfer information between elements within the computing device 112, such as during start-up, is stored in ROM 124. The computing device 112 further includes a flash memory 127, a magnetic disk drive 128 for reading from or writing to a removable magnetic disk 129, and an optical disk drive 130 for reading from or writing to a removable optical disk 131 such as a CD ROM, DVD, or other optical media.

The flash memory 127, magnetic disk drive 128, and optical disk drive 130 are connected to the system bus 123 by a flash memory interface 132, a magnetic disk drive interface 133, and an optical disk drive interface 134, respectively. The drives and their associated computer-readable media provide nonvolatile storage of computer-readable instructions, data structures, program modules, and other data for the computing device 112. It should be appreciated by those skilled in the art that any type of computer-readable media which can store data that is accessible by a computer, such as magnetic cassettes, hard disk drives, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the flash memory 127 and other forms of computer-readable media (e.g., the removable magnetic disk 129, the removable optical disk 131, flash memory cards, hard disk drives, SSD, USB drives, and the like) accessible by the processing unit 121 may be considered components of the system memory 122.

A number of program modules may be stored on the flash memory 127, magnetic disk 129, optical disk 131, ROM 124, or RAM 125, including an operating system 135, one or more application programs 136, other program modules 137, and program data 138. A user may enter commands and information into the computing device 12 through input devices such as a keyboard 140 and input device 142. The input device 142 may include touch sensitive devices (e.g., a stylus, touch pad, touch screen, or the like), a microphone, joystick, game pad, satellite dish, scanner, video camera, depth camera, or the like. In an embodiment, the user enters information into the computing device using an input device 142 that comprises a touch screen, such as touch screens commonly found on tablet computers (e.g., an iPad® 2). These and other input devices are often connected to the processing unit 121 through an input/output (I/O) interface 146 that is coupled to the system bus 123, but may be connected by other types of interfaces, including a serial port, parallel port, game port, a universal serial bus (USB), or a wireless interface (e.g., a Bluetooth interface). A monitor 147 or other type of display device is also connected to the system bus 123 via an interface, such as a video adapter 148. In addition to the monitor, computers typically include other peripheral output devices (not shown), such as speakers, printers, and haptic devices that provide tactile and/or other types physical feedback (e.g., a force feedback game controller).

The computing device 112 may operate in a networked environment using logical connections (wired and/or wireless) to one or more remote computers, such as remote computer 149. These logical connections are achieved by a communication device coupled to or a part of the computing device 112 (as the local computer). Implementations are not limited to a particular type of communications device or interface.

The remote computer 149 may be another computer, a server, a router, a network PC, a client, a memory storage device, a peer device or other common network node or device, and typically includes some or all of the elements described above relative to the computing device 112. The remote computer 149 may be connected to a memory storage device 150. The logical connections depicted in FIG. 8 include a local-area network (LAN) 151 (wired or wireless) and a wide-area network (WAN) 152. Such networking environments are commonplace in offices, enterprise-wide computer networks, intranets and the Internet.

Those of ordinary skill in the art will appreciate that a LAN may be connected to a WAN via a modem using a carrier signal over a telephone network, cable network, cellular network (e.g., a mobile communications network such as 3G, 4G, etc.), or power lines. Such a modem may be connected to the computing device 112 by a network interface (e.g., a serial or other type of port). Further, many laptop or tablet computers may connect to a network via a cellular data modem.

When used in a LAN-networking environment, the computing device 112 may be connected to the local area network 151 through a network interface or adapter 153 (wired or wireless), which is one type of communications device. When used in a WAN networking environment, the computing device 112 typically includes a modem 154, a type of communications device, or any other type of communications device for establishing communications over the wide area network 152 (e.g., the Internet), such as one or more devices for implementing wireless radio technologies (e.g., GSM, etc.).

The modem 154, which may be internal or external, is connected to the system bus 123 via the I/O interface 146. The modem 154 may be configured to implement a wireless communications technology (e.g., mobile telecommunications system, etc.). In a networked environment, program modules depicted relative to the personal computing device 112, or portions thereof, may be stored in the remote computer 149 and/or the remote memory storage device 150. It is appreciated that the network connections shown are exemplary and other means of and communications devices or interfaces for establishing a communications link between the computers may be used.

The computing device 112 and related components have been presented herein by way of particular example and also by abstraction in order to facilitate a high-level view of the concepts disclosed. The actual technical design and implementation may vary based on particular implementation while maintaining the overall nature of the concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

What is claimed is:

1. A computer-implemented method for providing a social media tool, comprising:
under the control of one or more computer systems configured with executable instructions,
verifying whether user computing devices each associated with a user are within a predetermined geographical area to identify authorized user computing devices;
receiving a plurality of topics from one or more of the identified authorized user computing devices over a data network;
receiving expressions of support for the plurality of topics by the users associated with the authorized user computing devices from the authorized user computing devices over the data network;
ranking at least a subset of the plurality of topics based on the received expressions of support for each topic; and
displaying a list of topics according to the ranking.

2. The computer-implemented method of claim 1, wherein displaying comprises displaying the list of topics on one or more user computing devices.

3. The computer-implemented method of claim 1, wherein displaying comprises displaying the list of topics on one or more digital surfaces other than user computing devices.

4. The computer-implemented method of claim 1, wherein each of the plurality of topics comprises a place, activity, event, concept, or a brand.

5. The computer-implemented method of claim 1, wherein the predetermined geographical area comprises a city.

6. The computer-implemented method of claim 1, further comprising receiving content related to a topic from one of the authorized user computing devices.

7. The computer-implemented method of claim 1, further comprising tracking received expressions of support for a plurality of users of authorized user computing devices, and ranking the plurality of users based the tracked received expressions of support.

8. The computer-implemented method of claim 7, further comprising displaying a list of users ordered dependent on the ranking of the plurality of users based on the tracked received expressions of support.

9. The computer-implemented method of claim 7, further comprising receiving content related to a topic from the authorized user computing devices, tracking the received content for users associated with the authorized user computing devices, and ranking the plurality of users based on the tracked received content.

10. The computer-implemented method of claim 7, further comprising tracking received expressions of support for a plurality of users of authorized user computing devices by topic, and ranking the plurality of users based the tracked received expressions of support for a particular topic.

11. The computer-implemented method of claim 1, further comprising designating a topic as a preferred topic, and displaying the preferred topic in a list of topics.

12. The computer-implemented method of claim 11, wherein designating a topic as a preferred topic comprising evaluating a bid received from an entity associated with the topic.

13. The computer-implemented method of claim 12, further comprising generating a user interest profile for a user associated with an authorized user computing device, wherein designating a topic as a preferred topic is dependent on the generated user interest profile.

14. The computer-implemented method of claim 1, further comprising associating an entity with a topic, receiving an expression of support for a user from the entity via a computing device over a network, and storing the expression of support for the user in a user profile.

15. The computer-implemented method of claim 1, wherein verifying whether user computing devices are within a predetermined geographical area comprises analyzing location data associated with the user computing devices.

16. The computer-implemented method of claim 1, further comprising receiving a bid associated with a topic for a preferred spot in a list of popular topics, and displaying the topic in the preferred spot dependent on an amount of the bid.

17. The computer-implemented method of claim 1, further comprising receiving expressions of support for the plurality of topics by the users associated with the authorized user computing devices via an interface associated with an external social media system.

18. A non-transitory computer-readable storage medium having stored thereon instructions that, when executed by one or more processors of a computer system, cause the computer system to implement at least:
a content collection and distribution server configured to:
verify whether user computing devices each associated with a user are within a predetermined geographical area to identify authorized user computing devices;
receive a plurality of topics from one or more of the identified authorized user computing devices over a data network;
receive expressions of support for the plurality of topics by the users associated with the authorized user computing devices from the authorized user computing devices over the data network;
rank at least a subset of the plurality of topics based on the received expressions of support for each topic; and
display a list of topics according to the ranking.

19. A system, comprising:
a computing device configured to:
verify whether user computing devices each associated with a user are within a predetermined geographical area to identify authorized user computing devices;
receive a plurality of topics from one or more of the identified authorized user computing devices over a data network;
receive expressions of support for the plurality of topics by the users associated with the authorized user computing devices from the authorized user computing devices over the data network;
rank at least a subset of the plurality of topics based on the received expressions of support for each topic; and
display a list of topics according to the ranking.
